(19) United States
(12) Patent Application Publication
(10) Pub. No.: US 2026/0142547 A1
(43) Pub. Date: May 21, 2026

(54) EMULATED CURRENT SENSE ADAPTATION

(71) Applicant: TEXAS INSTRUMENTS INCORPORATED, Dallas, TX (US)

(72) Inventors: Janne Pahkala, Oulu (FI); Antti Korhonen, Oulu (FI); Juha Hauru, Oulu (FI); Ari Vaananen, Oulu (FI); Jussi Sarkka, Oulu (FI)

(21) Appl. No.: 18/950,315

(22) Filed: Nov. 18, 2024

(51) Int. Cl. H02M 1/00; H02M 3/158

(52) U.S. Cl. CPC H02M 1/0009; H02M 3/1586

(57) ABSTRACT

A device comprising a first transistor, a second transistor, and a circuit. The first transistor has a current terminal and a control terminal. The second transistor has a current terminal and a control terminal. The current terminals of the first transistor and the second transistor are coupled together. The circuit has a first output, a second output, and an input coupled to the control terminal of the first transistor, the control terminal of the second transistor, and the current terminal of the second transistor respectively. The circuit is configured to: sample a comparison between a first voltage and a second voltage; responsive to the first voltage being larger than the second voltage, incrementing a value on a multi-bit bus; responsive to the second voltage being larger than the first voltage, decrementing the value on the multi-bit bus; and modifying the second voltage based on the value on the multi-bit bus.

### BACKGROUND

A current sensor measures the current flowing in a circuit, such as a direct current (DC)-DC converter. This measured current can be used in feedback to achieve better control of the switching of the DC-DC converter, and hence a more well-regulated output voltage from the DC-DC converter.

### SUMMARY

Some aspects relate to a device that comprises a first transistor, a second transistor, and a circuit. The first transistor has a current terminal and a control terminal. The second transistor has a current terminal and a control terminal. The current terminal of the second transistor is coupled to the current terminal of the first transistor. The circuit has a first output, a second output, and an input. The first output of the circuit is coupled to the control terminal of the first transistor. The second output of the circuit is coupled to the control terminal of the second transistor. The input of the circuit is coupled to the current terminal of the second transistor. The circuit is configured to: sample a comparison between a first voltage from the input and a second voltage; responsive to the first voltage being larger than the second voltage, incrementing a value on a multi-bit bus; responsive to the second voltage being larger than the first voltage, decrementing the value on the multi-bit bus; and modifying the second voltage based on the value on the multi-bit bus.

Some aspects relate to a device comprising a voltage reference circuit, a first switch, a delay-latch circuit, a capacitor, a current source, a second switch, and a comparator. The voltage reference circuit has an output terminal. The first switch has a first terminal, a second terminal, and a control terminal. The first terminal of the first switch is coupled to the output terminal of the voltage reference circuit. The delay-latch circuit has a first output terminal. The first output terminal of the delay-latch circuit is coupled to the control terminal of the first switch. The capacitor has a terminal coupled to the second terminal of the first switch. The current source has an output terminal. The second switch has a first terminal and a second terminal. The first terminal of the second switch is coupled to the output terminal of the current source. The second terminal of the second switch is coupled to the terminal of the capacitor. The comparator has a first input terminal and a second input terminal. The first input terminal of the comparator is coupled to the output terminal of the voltage reference circuit. The second input terminal of the comparator is coupled to the terminal of the capacitor.

Further some aspects relate to a system that comprises a control logic circuit, a first transistor, a second transistor, a current sense circuit, a control loop, and a comparator. The control logic circuit has an output terminal, a multi-bit bus output, and an input terminal. The first transistor has a control terminal and a current terminal. The control terminal of the first transistor is coupled to the output terminal of the control logic circuit. The second transistor has a control terminal and a current terminal. The control terminal of the second transistor is coupled to the output terminal of the control logic circuit. The current terminal of the first transistor is coupled to the current terminal of the second transistor. The current sense circuit has an input terminal, a multi-bit bus input, and an output terminal. The input terminal of the current sense circuit is coupled to the current terminal of the second transistor. The multi-bit bus input of the current sense circuit is coupled to the multi-bit bus output of the control logic circuit. The control loop circuit has an input terminal and an output terminal. The input terminal of the control loop circuit is coupled to the current terminal of the second transistor. The comparator has a first input terminal, a second input terminal, and an output terminal. The first input terminal of the comparator is coupled to the output terminal of the current sense circuit. The second input terminal of the comparator is coupled to the output terminal of the control loop circuit. The output terminal of the comparator is coupled to the input terminal of the control logic circuit.

### BRIEF DESCRIPTION OF THE DRAWINGS

FIG. 1 shows a buck converter that has multiple channels and multiple phase control circuits.

FIG. 2 shows a single channel and multiple circuit components that are in a phase control circuit.

FIG. 3A shows an example of a current sense circuit.

FIG. 3B shows another example of a current sense circuit.

FIG. 4 shows waveforms of signals within the current sense circuit.

FIG. 5 shows a rising time to sense current.

FIG. 6 shows a method for how a phase control circuit operates.

### DETAILED DESCRIPTION

A buck converter converts an input voltage into an output voltage. The buck converter takes measurements of the output voltage or an output current that makes the output voltage and uses the measurements in feedback to improve the accuracy of the output voltage. The buck converter may include circuit elements such as capacitors, inductors, resistors, or transistors. The circuit elements have tolerances or variations that can reduce the performance of the buck converter.

Thus, a buck converter circuit containing a current sense circuit is described. The current sense circuit operates by repeatedly updating an estimate for the current that makes the output voltage. The tolerances of the circuit elements and any other variations can be accounted for in the measurement by updating the estimate. Thus, the buck converter can achieve a more accurate output voltage because of the improved measurement.

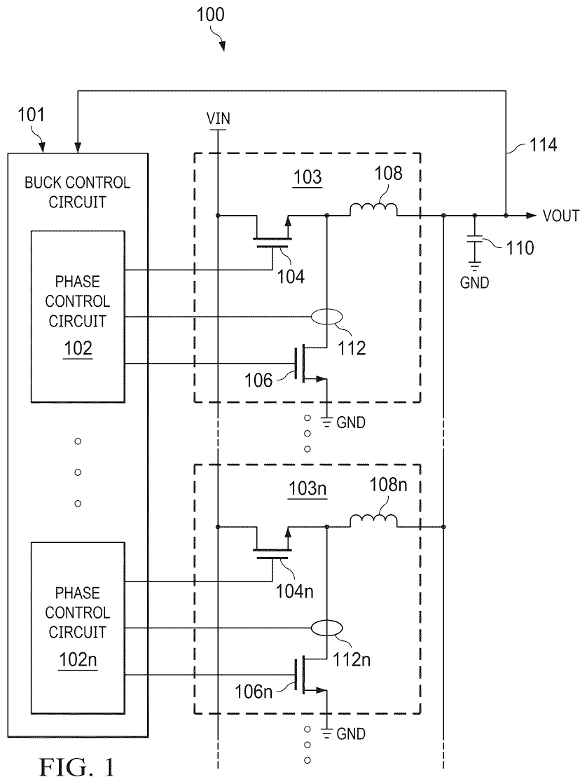

FIG. 1 shows a buck converter 100. The buck converter 100 has a buck control circuit 101, which includes n-channels, where n is any positive integer. The buck converter 100 also includes a first channel 103 through a nth-channel 103n, and a power capacitor 110. The buck control circuit 101 also has n phase control circuits, which include a first phase control circuit 102 through a nth-phase control circuit 102n. The first channel 103 has a first transistor 104, a second transistor 106, a first inductor 108, and a first measurement location 112. The nth-channel 103n has a nth-first transistor 104n, a nth-second transistor 106n, a nth-inductor 108n, and a nth-measurement location 112n.

The phase control circuit 102 has output terminals coupled to control terminals of the first transistor 104 and the second transistor 106. The first phase control circuit 102 also has an input terminal coupled to the first measurement location 112. The nth-phase control circuit 102n has output terminals coupled to control terminals of the nth-first transistor 104n and the nth-second transistor 106n. The nth-phase control circuit 102n also has an input terminal coupled to the nth-measurement location 112n.

The first transistor 104 has a first terminal coupled to VIN, and a second terminal coupled to a first terminal of the first inductor 108. The second transistor 106 has a first terminal coupled to the first terminal of the first inductor 108, and a second terminal coupled to GND. The first inductor 108 has a second terminal coupled to the first terminal of the power capacitor 110. Similarly, the nth-first transistor 104n has a first terminal coupled to VIN, and a second terminal coupled to a first terminal of the nth-inductor 108n. The nth-second transistor 106n has a first terminal coupled to the first terminal of the nth-inductor 108n, and has a second terminal coupled to GND. The second terminal of the nth-inductor 108n is coupled to the first terminal of the power capacitor 110. The first terminal or the second terminal of the first transistor 104 or the second transistor 106 may be current terminals because current flows in and out of the respective terminals.

During operation, the buck control circuit 101 provides control signals to the first transistor 104 through the nth-first transistor 104n and the second transistor 106 transistor through the nth-second transistor 106n at different rates to allow current to flow from input voltage (VIN) to the power capacitor 110. A feedback path 114 allows the buck control circuit 101 to monitor the output and “tune” the control signals in a manner that generates a stable output voltage (VOUT). The first transistor 104, the second transistor 106, the nth-first transistor 104n, and the nth-second transistor 106n may be MOSFETs, BJTs, or any other suitable transistor. The illustrated components of the buck converter 100 may be implemented on a semiconductor substrate (e.g., a single die, or a packaged chip that includes one or more die), or a printed circuit board (PCB). For example, the semiconductor substrate may be a monocrystalline silicon substrate, or a semiconductor on insulator (SOI) substrate. The first inductor 108 and nth-inductor 108n may be included with the various transistors and other components in the die/chip, or the first inductor 108 and nth-inductor 108n may be off-chip (e.g., in another discrete integrated circuit or other discrete component). The power capacitor 110 may also be on-chip or off-chip.

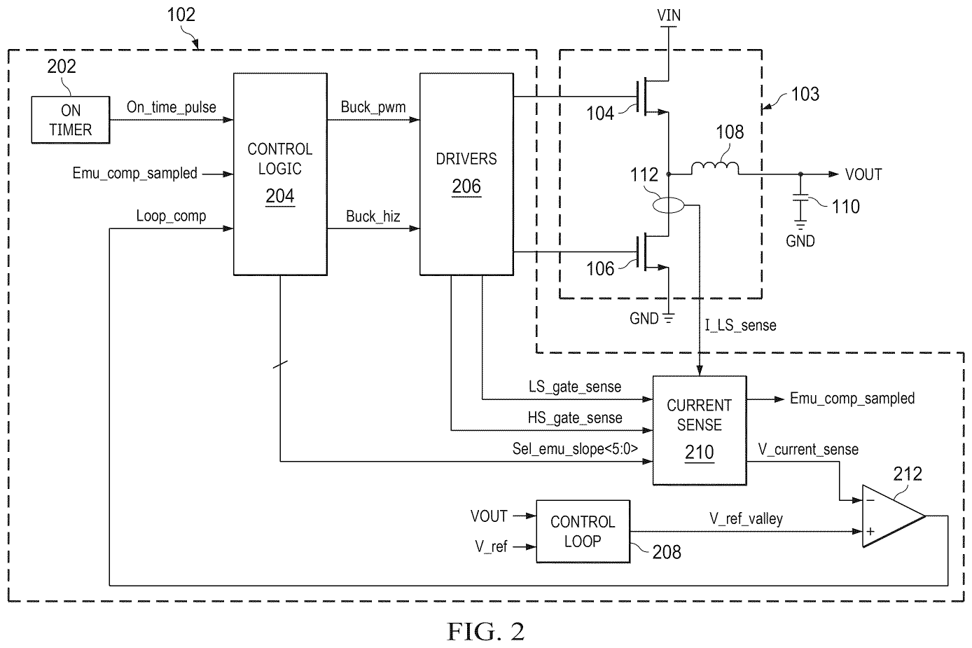

FIG. 2 shows an example implementation of the first phase control circuit 102. The first phase control circuit 102 contains an on timer circuit 202, a control logic circuit 204, drivers 206, a control loop circuit 208, a current sense circuit 210, and a feedback comparator 212 which function together in a system.

The components within the first phase control circuit 102 are coupled as follows. The on timer circuit 202 has a connection coupled to the control logic circuit 204 and that receives an on pulse signal, On_time_pulse. The control logic circuit 204 has connections for the transistor's pulse width modulation (PWM) signal and high impedance signal, Buck_pwm and Buck_hiz, respectively, coupled to the drivers 206. The control logic circuit 204 also has a multi-bit bus output for selecting the emulation slope signal, Sel_emu_slope<5:0>, coupled to a multi-bit bus input of the current sense circuit 210. The drivers 206 have outputs coupled to the control terminal of the first transistor 104 and the control terminal of the second transistor 106. The drivers 206 also have outputs for the low-side gate sensing signal and high-sided gate sensing signal, LS_gate_sense and HS_gate_sense respectively, coupled to the current sense circuit 210. The control loop circuit 208 has inputs of the output voltage, VOUT, and the reference voltage, V_ref, and has an output of the desired valley voltage, V_ref_valley, to the feedback comparator 212. The current sense circuit 210 also has a current low-side sense input, I_LS_sense, from the first measurement location 112. The current sense circuit 210 has an output that represents the emulation value being compared and sampled, Emu_comp_sampled, coupled to the control logic circuit 204 and has a voltage output indicative of the emulated current, V_current_sense, coupled to the feedback comparator 212. The feedback comparator 212 has an output as part of the feedback loop, Loop_comp, to the control logic circuit 204. The drivers 206 may alternatively be referred to as a gate driver circuit.

The control logic circuit 204 controls the first transistor 104 and the second transistor 106 to turn on and off at certain times to provide a stable VOUT. The control logic circuit 204 uses feedback through the Loop_comp signal from the feedback comparator 212 and the Emu_comp_sampled signal from the current sense circuit 210 to increase the accuracy of VOUT.

The current sense circuit 210 measures the current only through the second transistor 106 because the voltage VIN coupled to the first transistor 104 is too large. For example, VIN may have a value of 10-12 volts, while the current sense circuit 210 may operate at 3.3 or 5 volts. Thus, the current sense circuit 210 estimates, as opposed to measures, the current through the first transistor 104.

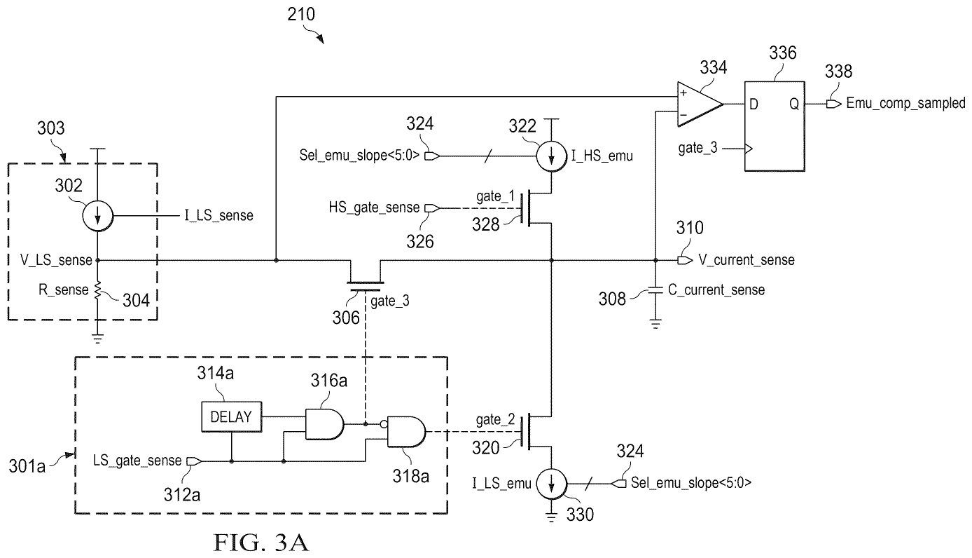

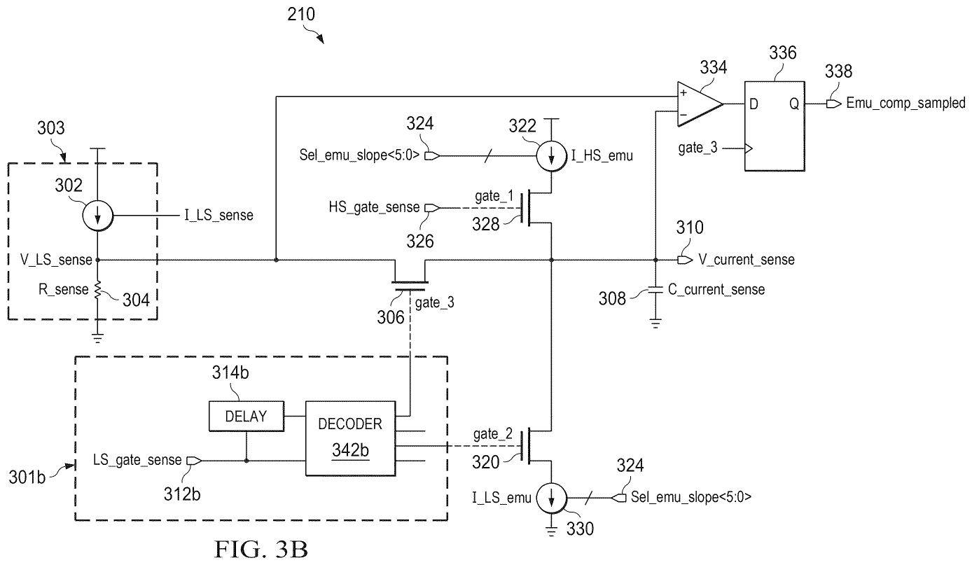

FIG. 3A provides an example implementation of the current sense circuit 210. The current sense circuit 210 has a voltage reference circuit 303, a delay-latch circuit 301a, a capacitor 308, an emulation bit bus input 324, a third current source 330, a current source 322, a high-side gate sense input 326, a first n-type metal oxide semiconductor (NMOS) transistor 328, a second NMOS transistor 320, a third NMOS transistor 306, a comparator 334, a D-flip flop 336, an emulation comparison sampled output 338, and a current sense output 310. The voltage reference circuit 303 has a second current source 302 and a sense resistor 304. The delay-latch circuit 301a has a low-side gate sense input 312a, a delay circuit 314a, a first AND gate 316a, and a second AND gate 318a.

The voltage reference circuit 303 has a first terminal coupled to a first terminal of the third NMOS transistor 306, and the voltage reference circuit 303 has terminals coupled to internal rails. Within the voltage reference circuit 303, the second current source 302 has a first terminal coupled to a first internal rail (e.g., VDD) and has an output coupled to the first terminal of the third NMOS transistor 306. The second current source 302 has an input coupled to I_LS_sense which is from the first measurement location 112. The sense resistor 304 has a first terminal coupled to the output of the second current source 302, and a second terminal coupled to a second internal rail (e.g., VSS). The delay-latch circuit 301a has a first output terminal coupled to the control terminal of the third NMOS transistor 306 and a second output terminal coupled to the control terminal of the second NMOS transistor 320. Within the delay-latch circuit 301a, the low-side gate sense input 312a is coupled to the input of the delay circuit 314a, an input of the first AND gate 316a, and an input of the second AND gate 318a. The delay circuit 314a has an output coupled to a second input of the first AND gate 316a. The output of the first AND gate 316a is coupled to a control terminal of the third NMOS transistor 306. The output of the first AND gate 316a is also coupled to an inverting input of the second AND gate 318a. The output of the second AND gate 318a is coupled to the control terminal of the second NMOS transistor 320.

The third NMOS transistor 306 has a second terminal coupled to a first terminal of the capacitor 308. The capacitor 308 has a second terminal coupled to the second internal rail. The emulation bit bus input 324 is coupled to the input of the third current source 330, and the input of the current source 322. The control terminal of the first NMOS transistor 328 is coupled to the high-side gate sense input 326. A first input of the comparator 334 is coupled to the output of the voltage reference circuit 303, and the second input of the comparator 334 is coupled to the first terminal of the capacitor 308. The input of the D-flip flop 336 is coupled to the output of the comparator 334. The trigger terminal of the D-flip flop 336 is coupled to the output of the first AND gate 316a. The output terminal of the current source 322 is coupled to the first terminal of the first NMOS transistor 328. A second terminal of the first NMOS transistor 328 is coupled to the first terminal of the capacitor 308. A first terminal of the second NMOS transistor 320 is coupled to the first terminal of the capacitor 308, and a second terminal of the second NMOS transistor 320 is coupled to the output of the third current source 330. The third current source 330 further has a second terminal coupled to the second internal rail.

The emulation bit bus input 324 is shown as Sel_emu_slope<5:0>, which has 6 bits and is from the control logic circuit 204. Alternatively, the emulation bit bus input 324 may have more or fewer bits. For example, the emulation bit bus input 324 may have between 1 bit and 16 bits, or between 6 bits and 1,000 bits, or any other suitable number of bits. The more bits that the emulation bit bus input 324 has, the more accurate the current sense output 310 can be. The fewer bits that the emulation bit bus input 324 has, the faster the response time is. This is because only 1 bit of comparison is being used for feedback from the output of the D-flip flop 336. Thus, there is a tradeoff such that having more bits or fewer bits corresponds with more accuracy or a faster response time.

The D-flip flop 336 may alternatively be any other suitable type of memory cell. For example, the D-flip flop 336 may alternatively be a JK flip-flop, RS flip-flop, master-slave flip-flop, a capacitor-type memory cell (e.g., a dynamic random access memory cell (DRAM)), a static random access memory cell (SRAM), among others. Also, the first NMOS transistor 328, the second NMOS transistor 320, and the third NMOS transistor 306 may alternatively be a BJT, a transfer gate, or any other suitable switching technology, or combination thereof.

By using feedback between the emulated current and the measured current, more accurate estimation can be provided to external circuits. Also, because a single comparator is used in the feedback path, the speed of the comparison is fast.

Alternatively, there may be more than 1 bit of comparison used in the feedback. For example, there may be multiple comparators and D-flip flops. By having multiple comparators and D-flip flops, the circuit can have a faster response time.

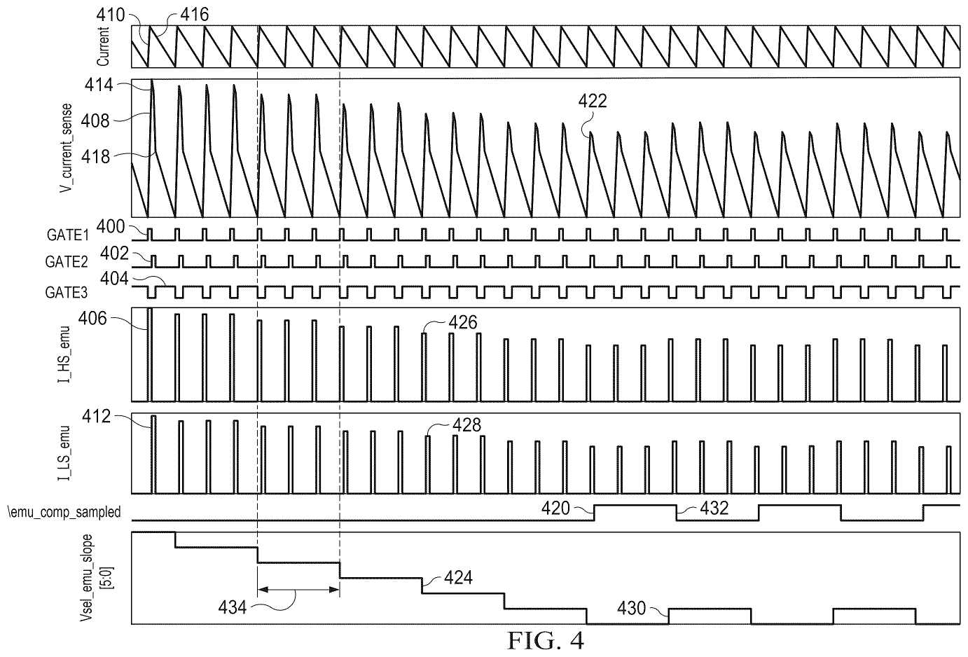

FIG. 4 shows the operation of the current sense circuit 210 in FIG. 3A. The description of the current sense circuit 210 of FIG. 3A is now made with reference to the waveforms of FIG. 4, such that FIG. 3A and FIG. 4 are described currently below. The current sense circuit 210 works by operating in three states. The first state is shown at 400 where the first NMOS transistor 328 is ON, and the third NMOS transistor 306 and the second NMOS transistor 320 are OFF. The second state is shown at 402 where the second NMOS transistor 320 is ON, and the third NMOS transistor 306 and the first NMOS transistor 328 are OFF. The third state is shown at 404 where the third NMOS transistor 306 is ON, and the first NMOS transistor 328 and the second NMOS transistor 320 are OFF. The first state also corresponds to the first transistor 104 being in an on state. The second state corresponds to the second transistor 106 being in an ON state for a first period of time. The third state corresponds to the second transistor 106 being in an ON state after a delay.

In the first state 400, the first NMOS transistor 328 is ON, and current flows from the current source 322 into the capacitor 308. The current from the current source 322 is shown at 406. Thus, the voltage output at the current sense output 310 increases which is shown at 408. The first state also occurs when the first transistor 104 is in an ON state, and the current flowing through the first inductor 108 is increasing which is shown at 410. So, the voltage on the capacitor 308 attempts to track the current through the first inductor 108. However, the voltage on the capacitor 308, V_current_sense, is shown at 408 to be larger than the current at 410 for illustrative purposes. For example, this difference between 408/410 can arise due to inductor current sense circuit delay and/or tolerances/variation in the various circuit components.

In the second state 402, the second NMOS transistor 320 turns ON, causing current to flow from the capacitor 308 into the third current source 330. The current through the third current source 330 is shown at 412, and the changing voltage on the capacitor 308 is shown at 414. Because the capacitor 308 is losing charge, the voltage on the capacitor 308 is decreasing. The decreasing voltage on the capacitor 308 corresponds with the decreasing current through the first inductor 108 which is shown at 416 when the second transistor 106 is in a conductive state.

In the third state 404, the third NMOS transistor 306 is ON, and the current through the second transistor 106 is measured by the current sense circuit 210. The measured current is provided to the capacitor 308 to cause the signal V_current_sense to line up with the current which is shown at 418. At the moment that the current sense circuit 210 switches from the second state to the third state (e.g., when the voltage on gate_3 goes high at 404), the D-flip flop 336 samples the output from the comparator 334 to signal whether the emulated current, which is stored on the capacitor 308 as V_current_sense, was greater than to the actual sense current. Because V_current_sense had over-predicted the value of the current at 418, the feedback through Emu_comp_sampled stays low.

After the third state, the first state starts over again. Also, the multi-bit bus, Sel_emu_slope, may be adjusted by one bit increments/decrements to attempt to obtain better estimation. For example, at 424 the value on the multi-bit bus is decremented because EMU_comp_sampled was low at 424, and the following current from the current source 322 and the third current source 330 is decreased which is shown at 426 and 428. By adjusting the amount of current from the current source 322 and the third current source 330, a better estimation of the current through the first inductor 108 can be achieved.

Alternatively, the multi-bit bus, Sel_emu_slope, may be adjusted by more than one bit increments/decrements. This may occur if there are multiple comparators.

The states repeat and eventually come to a steady state behavior where the current through the third current source 330 and the third current source 330 oscillate around an optimal value. For example, the value of the current from V_current_sense at 422 had underpredicted the current, so Emu_comp_sampled toggles to a high voltage at 420. This causes the multi-bit bus, Sel_emu_slope, to increment, instead of decrement, at 430, and I_HS_emu and I_LS_emu are incremented for the next cycle. The next cycle overpredicts, as shown at 432, and I_HS_emu and I_LS_emu are decremented for the next cycle.

Thus, the waveform shows that the emulation bit bus input 324 will be incremented or decremented to obtain a more accurate current emulation or estimation for the first transistor 104 and the second transistor 106. The high level of accuracy may take multiple cycles for the emulation bit bus input 324 to be adjusted to the correct value. So, there is a tradeoff between having more bits compared to having fewer bits in the emulation bit bus input 324. More bits would lead to more granularity or accuracy, or wider range, and fewer bits take fewer cycles to arrive at an accurate value and use less silicon area. The end result, however, is that because the emulation bit bus changes the emulated high side current and emulated low side current in a dynamic manner based on the Emu_comp_sampled signal, the emulated current more accurately accounts for small changes and/or variations in the circuit. The variations that are accounted for may be from the inductor and can include dynamically changing variables such as temperature, voltage, and current. Thus, the voltage output (Vout) provided by the circuit is more accurate/stable than previous approaches. Also, the circuit can provide a more accurate estimation for telemetry.

The value for Sel_emu_slope is shown to change every three cycles of each gate signal (e.g., see 434) in the example of FIG. 4. However, Sel_emu_slope may change every cycle or any number of cycles, and thus FIG. 4 is merely a non-limiting example.

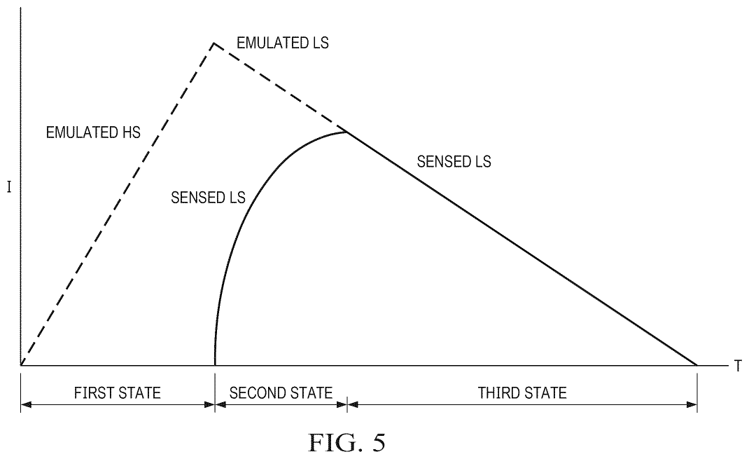

The second state and the third state introduce a delay to account for the rising time to measure the current through the second transistor 106. The delay is shown in more detail in FIG. 5. The delay-latch circuit 301a provides a delay before comparing the voltage stored on the capacitor 308 with a voltage indicative of the current through the second transistor 106. This delay is to wait for a rising time for the voltage reference circuit 303 to be able to measure a voltage.

The current source 322 and the third current source 330 change their output according to an input from the emulation bit bus input 324, Sel_emu_slope, to determine how much current to provide according to the following equations:

$$I\_HS \_emulated = Sel\_emu \_slope * ( VIN - VOUT ) * gm\_emu$$

$$I\_LS \_emulated = Sel\_emu \_slope * VOUT * gm\_emu$$

The above equations show that the current source 322 and the third current source 330, in combination with the capacitor 308, provide a linear approximation of the current through the first transistor 104 and the second transistor 106. The gm_emu, which may be referred to as an emulation transconductance, is a second value that may be a constant, set on the start-up of the device, or preconfigured in any other suitable matter. Thus, the values for I_HS_emulated and I_LS_emulated are based on a multiplication of a value stored on a multi-bit bus, Sel_emu_slope, with a second value, gm_emu.

FIG. 3B shows an alternative example of the delay-latch circuit 301b. The delay-latch circuit 301b has a delay circuit 314b, a decoder 342b, and a low-side gate sense input 312b. The delay circuit 314b has an input coupled to the low-side gate sense input 312b, and an output coupled to a first input of the decoder 342b. The decoder 342b has a second input coupled to the low-side gate sense input 312b. The decoder 342b has four outputs representing the four logical states from the two inputs. A first output of the decoder 342b is coupled to the control terminal of the second NMOS transistor 320, and signals when the input from the low-side gate sense input 312b is HIGH and the input from the delay circuit 314b is LOW. The second output of the decoder 342b is coupled to the control terminal of the third NMOS transistor 306, and signals when the input from the low-side gate sense input 312b is HIGH, and the input from the delay circuit 314b is HIGH. The second output of the decoder 342b is also coupled to the trigger input terminal of the D-flip flop 336. While multiple example implementations of the delay-latch circuit 301b have been shown, it has been appreciated that any other suitable circuit with the desired behavior may be used.

FIG. 5 shows emulated and sensed current through both the first transistor 104 and the second transistor 106. The dotted line in FIG. 5 is the emulated, or simulated, current. The solid line in FIG. 5 is the sensed, or measured, current. FIG. 5 shows a first state, a second state, and a third state that corresponds to gate_1 being high, gate_2 being high, and gate_3 being high respectively. For example, the first state, the second state, and the third state may occur at 400, 402, and 404 in FIG. 4.

During the first state, the first transistor 104 turns to a conductive state, leading to an increase in current. Thus, the emulated high-side current is shown to increase. During the second state, the first transistor 104 switches to a non-conductive state, and the second transistor 106 switches to a conductive state so that the current decreases. The sensed current through the second transistor 106 has a rising time before the value is accurate. So, the current through the second transistor 106 is emulated during the rising time. During the third state, the rising time has completed, and the current through the second transistor 106 can now be sensed, or measured. At the switch between the second state and the third state, the comparison takes place because the emulated current may not line up with the sensed current.

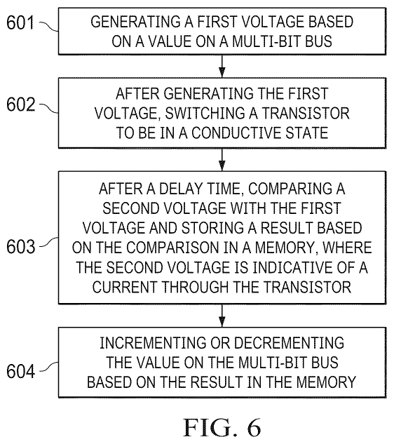

FIG. 6 shows a method detailing the operation of the first phase control circuit 102. The method includes four acts.

Act 601 involves the current sense circuit 210 generating a first voltage based on a value on a multi-bit bus. The generation of the first voltage may involve multiplying the value on the multi-bit bus with a second value. Act 602 involves after generating the first voltage, the control logic circuit 204 switches a transistor to be in a conductive state. Act 603 involves after a delay time after the switch, the current sense circuit 210 compares a second voltage with the first voltage and stores a result based on the comparison in a memory, where the second voltage is indicative of a current through the transistor. Act 604 involves the control logic circuit 204 incrementing or decrementing the value on the multi-bit bus based on the result in the memory.

The description above may apply to a boost converter circuit, a buck converter circuit, or a buck/boost converter circuit.

The methods are illustrated and described above as a series of acts or events, but the illustrated ordering of such acts or events is not limiting. For example, some acts or events may occur in different orders and/or concurrently with other acts or events apart from those illustrated and/or described herein. Also, some illustrated acts or events are optional to implement one or more aspects or embodiments of this description. Further, one or more of the acts or events depicted herein may be performed in one or more separate acts and/or phases. In some embodiments, the methods described above may be implemented in a computer-readable medium using instructions stored in a memory.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are illustrated and/or described herein, other transistors (or equivalent switching devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices described herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero. Modifications are possible in the described examples, and other implementations are possible, within the scope of the claims.

What is claimed is:

1. A device comprising:
a first transistor having a current terminal and a control terminal;
a second transistor having a current terminal and a control terminal, the current terminal of the second transistor coupled to the current terminal of the first transistor;
a circuit having a first output, a second output, and an input, the first output of the circuit coupled to the control terminal of the first transistor, the second output of the circuit coupled to the control terminal of the second transistor, the input coupled to the current terminal of the second transistor, and wherein the circuit is configured to:
sample a comparison between a first voltage from the input and a second voltage;
responsive to the first voltage being larger than the second voltage, incrementing a value on a multi-bit bus;
responsive to the second voltage being larger than the first voltage, decrementing the value on the multi-bit bus; and
modifying the second voltage based on the value on the multi-bit bus.

2. The device of claim 1, wherein the second voltage is modified based on a multiplication of the value on the multi-bit bus with a second value.

3. The device of claim 1, wherein the circuit is configured to perform the sample at a delay time after the second transistor is switched to a conductive state.

4. The device of claim 1, wherein the second voltage is indicative of a current through the first transistor.

5. The device of claim 1, wherein the incrementing and the decrementing adjusts the multi-bit bus by one bit.

6. The device of claim 1, wherein the incrementing and the decrementing adjusts the multi-bit bus by more than one bit.

7. A device comprising:
a voltage reference circuit having an output terminal;
a first switch having a first terminal, a second terminal, and a control terminal, the first terminal of the first switch coupled to the output terminal of the voltage reference circuit;
a delay-latch circuit having a first output terminal coupled to the control terminal of the first switch;
a capacitor having a terminal coupled to the second terminal of the first switch;
a current source having an output terminal;
a second switch having a first terminal and a second terminal, the first terminal of the second switch coupled to the output terminal of the current source, the second terminal of the second switch coupled to the terminal of the capacitor; and
a comparator having a first input terminal and a second input terminal, the first input terminal of the comparator coupled to the output terminal of the voltage reference circuit, the second input terminal of the comparator coupled to the terminal of the capacitor.

8. The device of claim 7, further comprising:
a memory cell having an input terminal coupled to an output terminal of the comparator.

9. The device of claim 8, wherein a trigger input terminal of the memory cell is coupled to the first output terminal of the delay-latch circuit.

10. The device of claim 9, wherein the voltage reference circuit comprises:
a second current source with an output terminal coupled to the output terminal of the voltage reference circuit; and
a resistor having a first terminal coupled to the output terminal of the second current source.

11. The device of claim 10, further comprising:
a third switch having a first terminal and a second terminal, the first terminal of the third switch coupled to the terminal of the capacitor; and
a third current source with an input terminal and an output terminal, the input terminal of the third current sources coupled to an input terminal of the second current source, the output terminal of the third current source coupled to the second terminal of the third switch, wherein the control terminal of the third switch is coupled to a second output terminal of the delay-latch circuit.

12. The device of claim 11, wherein an output current of the second current source is increased or decreased based on a value stored in the memory cell.

13. The device of claim 12, wherein the delay-latch circuit comprises:
a delay circuit having an output and an input;
a first AND gate having a first input, a second input, and an output, the first input of the first AND gate coupled to the input of the delay circuit, the second input of the first AND gate coupled to the output of the delay circuit, the output of the first AND gate coupled to a control terminal of the first switch; and
a second AND gate having an inverting input, an input, and an output, the inverting input coupled to the output of the first AND gate, the input of the second AND gate coupled to the input of the delay circuit, the output of the second AND gate coupled to the control terminal of the third switch.

14. The device of claim 7, further comprising:
a first transistor having a current terminal; and
a second transistor having a current terminal coupled to the current terminal of the first transistor, an input terminal of the voltage reference circuit coupled to the current terminal of the second transistor.

15. The device of claim 14, wherein the delay-latch circuit has an input terminal coupled to a control terminal of the second transistor.

16. The device of claim 15, wherein the second switch has a control terminal coupled to a control terminal of the first transistor.

17. A system comprising:
a control logic circuit having an output terminal, a multi-bit bus output, and an input terminal;
a first transistor having a control terminal and a current terminal, the control terminal of the first transistor coupled to the output terminal of the control logic circuit;
a second transistor having a control terminal and a current terminal, the control terminal of the second transistor coupled to the output terminal of the control logic circuit, and the current terminal of the first transistor coupled to the current terminal of the second transistor;
a current sense circuit having an input terminal, a multi-bit bus input, and an output terminal, the input terminal of the current sense circuit coupled to the current terminal of the second transistor, the multi-bit bus input of the current sense circuit coupled to the multi-bit bus output of the control logic circuit;
a control loop circuit having an input terminal and an output terminal, the input terminal of the control loop circuit coupled to the current terminal of the second transistor; and
a comparator having a first input terminal, a second input terminal, and an output terminal, the first input terminal of the comparator coupled to the output terminal of the current sense circuit, the second input terminal of the comparator coupled to the output terminal of the control loop circuit, the output terminal of the comparator coupled to the input terminal of the control logic circuit.

18. The system of claim 17, wherein the current sense circuit has a second output terminal coupled to a third input terminal of the control logic circuit.

19. The system of claim 17, further comprising:
a gate driver circuit having an input terminal, a first output terminal, and a second output terminal, the input terminal of the gate driver circuit coupled to the first output terminal of the control logic circuit, the first output terminal of the gate driver circuit coupled to the control terminal of the first transistor, and the second output terminal of the gate driver circuit coupled to the control terminal of the second transistor.

20. The system of claim 19, wherein the gate driver circuit further has a third output terminal and a fourth output terminal, the third output terminal of the gate driver circuit coupled to a third input terminal of the current sense circuit, and the fourth output terminal of the gate driver circuit coupled to a fourth input terminal of the current sense circuit.

21. The system of claim 17, further comprising:
an inductor having a first terminal and a second terminal, the first terminal of the inductor coupled to the current terminal of the first transistor, and the second terminal of the inductor coupled to the input terminal of the control loop circuit.

22. The system of claim 21, further comprising:
a second control logic circuit having an output terminal, a multi-bit bus output, and an input terminal;
a third transistor having a control terminal and a current terminal, the current terminal of the third transistor coupled to the output terminal of the second control logic circuit;
a fourth transistor having a control terminal and a current terminal, the control terminal of the fourth transistor coupled to the output terminal of the second control logic circuit, and the current terminal of the third transistor coupled to the current terminal of the fourth transistor;
a second current sense circuit having an input terminal, a multi-bit bus input, and an output terminal, the input terminal of the second current sense circuit coupled to the current terminal of the fourth transistor, the multi-bit bus input of the second current sense circuit coupled to the multi-bit bus input of the second control logic circuit.
a second control loop circuit having an input terminal and an output terminal, the input terminal of the second control loop circuit coupled to the current terminal of the fourth transistor;
a second comparator having a first input terminal, a second input terminal, and an output terminal, the first input terminal of the second comparator coupled to the output terminal of the second current sense circuit, the second input terminal of the second comparator coupled to the output terminal of the second control loop circuit, the output terminal of the second comparator coupled to the input terminal of the second control logic circuit; and
a second inductor having a first terminal and a second terminal, the first terminal of the second inductor coupled to the current terminal of the fourth transistor, the second terminal of the second inductor coupled to the input terminal of the second control loop circuit, and wherein the second terminal of the second inductor is coupled to the second terminal of the inductor.
